(19) United States
(12) Patent Application Publication
(10) Pub. No.: US 2025/0210694 A1
(43) Pub. Date: Jun. 26, 2025

(54) SOLID ELECTROLYTE LAYER AND METHOD FOR MANUFACTURING SOLID-STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 18/966,642

(22) Filed: Dec. 3, 2024

(30) Foreign Application Priority Data
Dec. 26, 2023 (JP) 2023-219120

(51) Int. Cl. H01M 10/0562; H01M 10/04; H01M 10/0525

(52) U.S. Cl. CPC H01M 10/0562; H01M 10/0468; H01M 10/0525; H01M 2300/0068; H01M 2300/0094

(57) ABSTRACT

The solid electrolyte layer for a solid-state battery includes a nonwoven fabric and a solid electrolyte, and the solid electrolyte is placed inside the nonwoven fabric, and the ratio of the volume of the nonwoven fabric to the volume of the solid electrolyte layer is 35% or more and 54% or less.

### CROSS-REFERENCE TO RELATED APPLICATION

This application claims priority to Japanese Patent Application No. 2023-219120 filed on Dec. 26, 2023, incorporated herein by reference in its entirety.

### BACKGROUND

### 1. Technical Field

The present disclosure relates to solid electrolyte layers and methods for manufacturing a solid-state battery.

### 2. Description of Related Art

Various techniques have been proposed regarding a solid electrolyte layer including a nonwoven fabric as disclosed in Japanese Unexamined Patent Application Publication No. 2016-031789 (JP 2016-031789 A), Japanese Unexamined Patent Application Publication No. 2020-188026 (JP 2020-188026 A), and Japanese Unexamined Patent Application Publication No. 2023-515016 (JP 2023-515016 A).

### SUMMARY

In the solid electrolyte layer including a nonwoven fabric, the resistance increases if the basis weight of the nonwoven fabric is too large, and the tensile strength decreases if the basis weight of the nonwoven fabric is too small.

The present disclosure was made in view of the above circumstances, and a primary object of the present disclosure is to provide a solid electrolyte layer and a method for manufacturing a solid-state battery that can reduce an increase in resistance.

The present disclosure includes the following aspects.

(1) A solid electrolyte layer for a solid-state battery includes:
a nonwoven fabric; and a solid electrolyte.

The solid electrolyte is disposed in the nonwoven fabric. A ratio of a volume of the nonwoven fabric to a volume of the solid electrolyte layer is 35% or more and 54% or less.

(2) In the solid electrolyte layer according to (1), the nonwoven fabric may have a porosity of 73% or more and 83% or less.

(3) In the solid electrolyte layer according to (1) or (2), the nonwoven fabric may be composed of polyethylene terephthalate.

(4) In the solid electrolyte layer according to any one of (1) to (3), the solid electrolyte may include a sulfide solid electrolyte.

(5) A method for manufacturing a solid-state battery includes: obtaining a stack by disposing the solid electrolyte layer according to any one of (1) to (4) between an anode layer and a cathode layer; and pressing the stack.

The present disclosure can provide a solid electrolyte layer and a method for manufacturing a solid-state battery that can reduce an increase in resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between the volume ratio (%) of the nonwoven fabric in each of the solid electrolyte layers, the tensile strength of each of the solid electrolyte layers, and the resistance of each of the solid-state batteries prepared in Examples 1 to 5 and Comparative Examples 2 and 3.

### DETAILED DESCRIPTION OF EMBODIMENTS

Hereinafter, embodiments according to the present disclosure will be described. Note that matters other than those specifically mentioned in the present specification and necessary for the implementation of the present disclosure can be understood as design matters of a person skilled in the art based on the prior art in the field. What is needed in the practice of the present disclosure is, for example, a solid electrolyte layer that does not characterize the present disclosure and the general construction and manufacturing process of a solid-state battery. The present disclosure can be carried out based on content disclosed in the present specification and common knowledge in the technical field.

In the present disclosure, unless otherwise specified, the average particle diameter of the particles is a value of the median diameter (D50) which is the particle diameter at an integrated value of 50% in a volume-based particle size distribution measured by laser diffraction/scattering particle size distribution measurement.

### 1. Solid Electrolyte Layer

The present disclosure provides a solid electrolyte layer for a solid-state battery described below.
The solid electrolyte layer includes a nonwoven fabric and a solid electrolyte.
The solid electrolyte is placed inside the nonwoven fabric.
The ratio of the volume of the nonwoven fabric to the volume of the solid electrolyte layer is 35% or more and 54% or less.

In the present disclosure, in the solid electrolyte layer including the nonwoven fabric, by setting the ratio of the volume of the nonwoven fabric to the volume of the solid electrolyte layer to a predetermined range, the number of fibers of the nonwoven fabric is reduced and the pore diameter is increased. As a result, while maintaining the desired tensile strength of the solid electrolyte layer, the solid electrolyte (SE) grains in the solid electrolyte layer are easily contacted with each other, the ion-conducting pass is increased, and an increase in resistivity due to the inclusion of the nonwoven fabric can be suppressed.

The solid electrolyte layer of the present disclosure includes a nonwoven fabric and a solid electrolyte, and optionally includes a binder or the like. The solid electrolyte layer of the present disclosure is for a solid-state battery.

A “nonwoven fabric” is a sheet-like fabric that is bonded or entangled without weaving fibers. Also, the term “nonwoven fabric” refers to a planar fibrous aggregate that has been subjected to a predetermined level of structural strength by physical and/or chemical methods other than weaving, knitting, and papermaking (JISL0222:2022). The fiber assembly has a plurality of pores.

“Pore size” refers to the largest pore size according to the bubble-point method (JISK3832). The shape of the solid electrolyte layer in plan view is not particularly limited, and examples thereof include a rectangle. Rectangles include squares, rectangles, and the like.

The thickness of the solid electrolyte layer depends on the thickness of the nonwoven fabric and may be greater than or equal to the thickness of the nonwoven fabric.

The thickness of the solid electrolyte layer may be 50 μm or less or 30 μm or less from the viewpoint of reducing the resistance of the solid-state battery. The thickness of the solid electrolyte layer may be 1 μm or more.

### Nonwoven Fabric

Types of nonwoven fabrics include, but are not limited to, for example, meltblown nonwoven fabric, spunbonded nonwoven fabric, carded nonwoven fabric, parallel-laid nonwoven fabric, cross-laid nonwoven fabric, random-laid nonwoven fabric, spun-laid nonwoven fabric, flashspun nonwoven fabric, chemical bonded nonwoven fabric, hydroentangled nonwoven fabric, needlepunched nonwoven fabric, stitchbonded nonwoven fabric, thermobonded nonwoven fabric, burst fiber nonwoven fabric, tow opening nonwoven fabric, and film split nonwoven fabric.

Examples of the material of the nonwoven fabric include resin and glass. Examples of the resin include polyester-based resins, polyolefin-based resins, and polyamide-based resins. Examples of the polyester-based resin include polyethylene terephthalate (PET) and the like. Examples of the polyolefin-based resin include polyethylene (PE) and polypropylene (PP).

Examples of the polyamide-based resin include nylon and aramid. The nonwoven fabric may be made of polyethylene terephthalate from the viewpoint that it has high heat resistance and hardly deteriorates even at high temperatures.

The porosity of the nonwoven fabric is not particularly limited, and may be greater than 69%, greater than or equal to 70%, or greater than or equal to 73% from the viewpoint of further reducing the resistance of the solid-state battery. The porosity of the nonwoven fabric may be less than 84% or may be 83% or less from the viewpoint that the resistance can be reduced while maintaining the tensile strength of the solid electrolyte layer. The porosity of the nonwoven fabric may be 73% or more and 83% or less.

Porosity refers to the volume of voids inside the nonwoven fabric relative to the total volume of the nonwoven fabric.

The porosity of the nonwoven fabric can be calculated by calculating the volume of the void from the difference between the actual volume of the nonwoven fabric and the volume calculated from the specific gravity of the material, and determining the ratio of the volume of the void to the actual volume of the nonwoven fabric.

The average fiber diameter of the nonwoven fabric is not particularly limited.

The fibers of the nonwoven fabric may be long fibers or single fibers. The cross-sectional shape of the fiber is not particularly limited, and examples thereof include a circular shape, an oval shape, and a deformed shape.

The thickness of the nonwoven fabric is not particularly limited, and may be 10 μm or more, 60 μm or less, or 30 μm or less. When the thickness of the nonwoven fabric is 10 μm to 60 μm, the thickness of the solid electrolyte layer of the solid-state battery can be made thinner.

As a result, the resistance of the solid-state battery can be further reduced.

The basis weight of the nonwoven fabric is not particularly limited, and may be 0.10 g/cm² or more and 1 g/cm² or less from the viewpoint of further reducing the battery resistivity of the solid-state battery or the like.

The pore diameter of the nonwoven fabric is not particularly limited, and may be 1 μm to 15 μm.

The nonwoven fabric can be produced by a conventionally known method such as a meltblown method and a spunbond method, and the average fiber diameter, pore diameter, thickness, and porosity of the nonwoven fabric can be controlled by a conventionally known method.

### Solid Electrolyte

The solid electrolyte is placed inside the nonwoven fabric. The solid electrolyte may cover the nonwoven fabric or may not cover the nonwoven fabric as long as it is placed inside the nonwoven fabric.

Examples of the solid electrolytes include inorganic solid electrolytes such as a sulfide solid electrolyte, an oxide solid electrolyte, a hydride solid electrolyte, a halide solid electrolyte, and a nitride solid electrolyte, and organic polymer electrolytes such as a polymer electrolyte. From the viewpoint of suppressing the separation of the cathode layer and the anode layer from the solid electrolyte layer and further reducing the resistance of the solid-state battery, a relatively soft sulfide solid electrolyte may be used as the solid electrolyte. Only one type of solid electrolyte may be used alone, or two or more types of solid electrolyte may be used in combination. Further, when two or more kinds of solid electrolytes are used, two or more kinds of solid electrolytes may be mixed, or two or more layers of each solid electrolyte may be formed to form a multilayer structure.

The proportion of the solid electrolyte in the solid electrolyte layer is not particularly limited, but may be, for example, 50% by mass or more and 99% by mass or less.

The ratio of the total volume of the solid electrolyte to the total volume of the voids in the nonwoven fabric may be 50% by volume or more, 70% by volume or more, or 90% by volume or more.

Examples of the sulfide solid electrolyte include a solid electrolyte including an Li element, an A element, and an S element. The A element is at least one of P, As, Sb, Si, Ge, Sn, B, Al, Ga, and In. The sulfide solid electrolyte may further contain at least one of an O element and a halogen element. Examples of the halogen element (X) include F element, Cl element, Br element, I element, and the like. The sulfide solid electrolyte may be glass (amorphous), glass ceramics, or crystalline. When the sulfide solid electrolyte is a crystalline, the sulfide solid electrolyte has a crystalline phase. Examples of the crystalline phase include a Thio-LISICON crystalline phase, a LGPS crystalline phase, and an argyrodite crystalline phase. Examples of the sulfide solid electrolyte include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂. Note that the description of “Li₂S—P₂S₅” means a material made of a raw material composition containing Li₂S and P₂S₅, and the same applies to other descriptions. The molar ratio of each element in the sulfide solid electrolyte can be controlled by adjusting the content of each element in the raw material. In addition, the molar ratio and the composition of the respective elements in the sulfide solid electrolyte can be measured, for example, by ICP emission spectrometry.

Examples of the oxide solid electrolyte include a solid electrolyte containing an Li element, a Z element (Z is at least one of Nb, B, Al, Si, P, Ti, Zr, Mo, W, and S), and an O element. Examples of the oxide solid electrolyte include Li₂O—B₂O₃—P₂O₅, Li₂O—SiO₂, Li₂O—B₂O₃, Li_{1.3}Al_{0.3}Ti_{0.7} (PO₄)₃, Li₅La₃Ta₂O₁₂, Li₅La₃Zr₂O₁₂, Li₆BaLa₂Ta₂O₁₂, Li_{3.6}Si_{0.6}P_{0.4}O₄, Li₄SIO₄, Li₃PO₄, and Li₃₊ₓPO₄₋ₓNₓ (1≤x≤3).

The hydride solid electrolyte has, for example, Li and hydrogen-containing complex anions. Examples of the complex anion include (BH₄)⁻, (NH₂)⁻, (AlH₄)⁻, and (AlH₆)³⁻. Examples of the halogenated solid electrolyte include LiF, LiCl, LiBr, LiI, and LiI—Al₂O₃. Examples of the nitride solid electrolyte include Li₃N.

Examples of the binder include a rubber-based binder and a fluoride-based binder. Examples of the rubber-based binder include butadiene rubber, hydrogenated butadiene rubber, styrene butadiene rubber (SBR), hydrogenated styrene butadiene rubber, nitrile butadiene rubber, hydrogenated nitrile butadiene rubber, and ethylene propylene rubber. Examples of the fluoride-based binder include polyvinylidene fluoride (PVDF), polyvinylidene fluoride-polyhexafluoropropylene copolymer (PVDF-HFP), polytetrafluoroethylene, and fluororubber.

When the solid electrolyte layer contains a binder, the content of the binder may be 0 parts by mass to 3 parts by mass with respect to the total amount of the solid electrolyte layer.

The solid electrolyte is a solid electrolyte particle.

The average particle diameter (D50) of the solid electrolyte particles is not particularly limited, but may be 0.1 μm or more, 0.5 μm or more, or 100 μm or less, or 10 μm or less from the viewpoint of reducing the battery resistivity.

### Ratio of Volume of Nonwoven Fabric to Volume of Solid Electrolyte Layer

In the present disclosure, the ratio of the volume of the nonwoven fabric to the volume of the solid electrolyte layer is 35% or more and 54% or less.

The ratio of the volume of the nonwoven fabric to the volume of the solid electrolyte layer can be varied by controlling the porosity of the nonwoven fabric, controlling the basis weight of the solid electrolyte to the nonwoven fabric, and the like.

The solid electrolyte layer can be formed, for example, by the following method.

A solid electrolyte paste including a solid electrolyte, a binder, and a solvent may be prepared, a nonwoven fabric may be disposed on a release film, and the solid electrolyte paste may be applied to the nonwoven fabric disposed on the release film to form a solid electrolyte layer. Solvents include, for example, butyl acetate, butyl butyrate, heptane, and N-methyl-2-pyrrolidone.

### 2. Solid-State Battery

A solid-state battery of the present disclosure includes an anode including an anode layer, a cathode including a cathode layer, and a solid electrolyte layer of the present disclosure disposed between the anode layer and the cathode layer.

In the present disclosure, a solid-state battery means a battery including a solid electrolyte. The solid-state battery may be a semi-solid-state battery that is a solid-state battery including a solid electrolyte and a liquid-based material, or may be an all-solid-state battery that is a solid-state battery that does not include a liquid-based material.

When the set of the cathode, the solid electrolyte layer, and the anode is used as the power generation unit, the solid-state battery may have only one power generation unit or two or more power generation units. When the solid-state battery has two or more power generation units, the power generation units may be connected in series or in parallel.

### Cathode

The cathode includes a cathode layer. The cathode optionally includes a cathode current collector.

### Cathode Layer

The cathode layer contains a cathode active material, and may contain a solid electrolyte, a conductive material, a binder, and the like, if necessary.

Examples of the cathode active material include a lithium-nickel-cobalt aluminum oxide (NCA), LiCoO₂, LiNiₓCo₁₋ₓO₂ (0<x<1), LiNi_{1/3}Co_{1/3}Mn_{1/3}O₂, LiMnO₂, LiMn₂O₄, LiNiO₂, LiVO₂, heterogeneous element-substituted Li—Mn spinel, lithium titanate, metal lithium phosphate, LiCON, Li₂SiO₃, and Li₄SiO₄. The heterogeneous element-substituted Li—Mn spinel includes, for example, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. Lithium titanate includes, for example, Li₄Ti₅O₁₂. Lithium metal phosphate includes, for example, LiFePO₄, LiMnPO₄, LiCoPO₄, and LiNiPO₄. The cathode active material may be an active material containing an Ni element and a Co element.

The shape of the cathode active material is not particularly limited, but may be particulate (cathode active material particles). The average particle diameter of the cathode active material particles is not particularly limited, and may be 100 μm from 1 nm.

A Li ion-conductive oxide may be formed on the cathode active material. This is because the reaction between the cathode active material and the solid electrolyte can be suppressed. Examples of Li ion-conductive oxide include LiNbO₃, Li₄Ti₅O₁₂, and Li₃PO₄. The thickness of the coating layers is, for example, 0.1 nm or more, and may be 1 nm or more. On the other hand, the thickness of the coating layers may be, for example, less than or equal to 100 nm and less than or equal to 20 nm. The coating ratio of the coating layer on the surface of the cathode active material is, for example, 70% or more, and may be 90% or more.

As the conductive material, a known material can be used, and examples thereof include carbon materials and metal particles. Examples of the carbon material include acetylene black (AB), furnace black, VGCF, carbon nanotubes, and carbon nanofibers. Among the above, from the viewpoint of electron conductivity, at least one selected from the group consisting of VGCF, a carbon nanotube, and a carbon nanofiber may be used. Examples of metal particles include particles of Ni, Cu, Fe, and SUS. The content of the conductive material in the cathode layer is not particularly limited.

Examples of the solid electrolyte include a solid electrolyte that can be contained in the above-described solid electrolyte layer.

The content of the solid electrolyte in the cathode layer is not particularly limited, but may be, for example, within a range of 1% by mass to 80% by mass, where the total mass of the cathode layer is 100% by mass.

Examples of the binder include binders that can be contained in the above-described solid electrolyte layer. The content of the binder in the cathode layer is not particularly limited.

The thickness of the cathode layer is not particularly limited.

The cathode layer can be formed by a conventionally known method. For example, a cathode paste is prepared by charging a cathode active material and, if necessary, other components into a solvent and stirring, and the cathode paste is coated on one surface of a support such as a cathode current collector and dried to obtain a cathode layer.

Examples of the solvent include a solvent that can be used for producing the above-described solid electrolyte paste.

The method of applying a positive pole paste on one face of a support such as a positive current collector is not particularly limited, including, but not limited to, the doctor blade method, metal mask printing method, electrostatic application method, dip-coat method, spray-coat method, roll-coat method, gravure coating method, and screen printing method. As the support body, a support body with self-supporting properties can be appropriately selected and used, and there is no particular limitation. For example, metal foils such as Cu and Al can be used.

### Cathode Current Collector

As the cathode current collector, a known metal that can be used as a current collector of a solid-state battery can be used. As the metals above, a metal material containing one or more elements selected from the group consisting of Cu, Ni, Al, V, Au, Pt, Mg, Fe, Ti, Co, Cr, Zn, Ge, and In can be exemplified. Examples of cathode current collectors include SUS, aluminum, nickel, iron, titanium, and carbon.

The shape of the cathode current collector is not particularly limited, and various shapes such as a foil shape and a mesh shape can be used.

### Anode

The anode includes an anode layer. The anode optionally includes an anode current collector.

### Anode Layer

The anode layer includes an anode active material. The anode layer may optionally contain at least one of a solid electrolyte, a conductive material, and a binder. Examples of the anode active material include a Li active material, a carbon-based active material, an oxide-based active material, and a Si active material, and may be a Si active material. Examples of Li active material include metallic lithium and lithium alloys. Examples of the carbon-based active material include graphite, hard carbon, and soft carbon. Examples of the oxide-based active material include lithium titanate. Examples of Si active material include Si alone, Si alloy, and silicon oxide.

Examples of the shape of the anode active material include particulate. The average particle diameter of the anode active material particles is not particularly limited, and may be 100 μm from 1 nm.

Examples of the conductive material, the solid electrolyte, and the binder used in the anode layer include the same materials as those exemplified as the conductive material, the solid electrolyte, and the binder that can be included in the cathode layer. The thickness of the anode layer is not particularly limited, and may be 0.1 μm to 1000 μm.

### Anode Current Collector

The material of the anode current collector may be a material that does not alloy with Li, and may be, for example, SUS, copper, and nickel. Examples of the shape of the anode current collector include a foil shape and a plate shape. The shape of the anode current collector in plan view is not particularly limited, and examples thereof include a circular shape, an elliptical shape, a rectangular shape, and an arbitrary polygonal shape. The thickness of the anode current collector varies depending on the shape, but may be, for example, in a range of 1 μm to 50 μm or in a range of 5 μm to 20 μm.

### Solid Electrolyte Layer

A solid-state battery comprises a solid electrolyte layer of the present

### DISCLOSURE

The nonwoven fabric included in the solid electrolyte layer and at least one of the cathode layer and the anode layer may or may not be in direct contact with each other. Another solid electrolyte layer may be disposed between the nonwoven fabric included in the nonwoven fabric of the solid electrolyte layer and at least one of the cathode layer and the anode layer. By disposing another solid electrolyte layer, the internal resistance of the solid-state battery is reduced. Another solid electrolyte layer contains a solid electrolyte and may optionally contain a binder. Examples of the solid electrolyte and the binder include the same as those exemplified as the solid electrolyte and the binder that may be included in the solid electrolyte layer of the present disclosure. Another solid electrolyte layer does not contain a nonwoven fabric. The thickness of the other solid electrolyte layer is not particularly limited.

The solid-state battery includes an exterior body that houses a cathode layer, an anode layer, a solid electrolyte layer, and the like, if necessary.

The material of the exterior body is not particularly limited as long as it is stable in the solid electrolyte, and examples thereof include resins such as aluminum, polypropylene, polyethylene, and acrylic resin.

As the shape of the solid-state battery, for example, coin-type, laminate-type, cylindrical, and square-type, and the like.

The solid-state battery may be a primary battery or a secondary battery. Applications of solid-state batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. Among them, it may be used as a power source for driving hybrid electric vehicle (HEV), plug-in hybrid electric vehicle (PHEV), or battery electric vehicle (BEV). Further, the solid-state battery may be used as a power source for a moving object (for example, a railway, a ship, an aircraft, or the like) other than the vehicle, or may be used as a power source for an electric product such as an information processing apparatus.

### 3. Method for Manufacturing Solid-State Battery

A method of manufacturing a solid-state battery of the present disclosure includes a step of obtaining a stack by disposing a solid electrolyte layer of the present disclosure between an anode layer and a cathode layer, and a step of pressing the stack. In the step of obtaining the stack, the solid electrolyte layer of the present disclosure may be disposed on a first electrode of one of the cathode layer and the anode layer, and the solid electrolyte layer of the present disclosure may be pressed in advance. Then, the release film may be peeled from the nonwoven fabric, and a second electrode of the other of the cathode layer and the anode layer may be disposed on the solid electrolyte layer to obtain a stack. The pressing pressure in the pressing step is not particularly limited, but may be larger than the pressing pressure in the pre-pressing.

The pressing method is not particularly limited, and examples thereof include a roll press. Depending on the pressing in the pressing step, each of the nonwoven fabric and the solid electrolyte contained in the solid electrolyte layer is less likely to be deformed. Therefore, each of the nonwoven fabric and the solid electrolyte included in the solid electrolyte layer after the pressing and each of the nonwoven fabric and the solid electrolyte included in the solid electrolyte layer before the pressing can be regarded as being the same.

### Example 1

### Preparation of Nonwoven Fabric

A nonwoven fabric made of a PET having a thickness of 30 μm and a porosity of 83% as shown in Tables 1 was prepared. The basis weight of the nonwoven fabric was 1 g/cm².

### Preparation of Solid Electrolyte Layer

As the sulfide solid electrolyte, glass-ceramic particles having an average particle diameter (D50) of 1 μm in 15LiBr·10LiI·75 (0.75Li₂S 0.25P₂S₅) shown in Table 1 were used. SBR (styrene-butadiene rubber)-based binder is weighed in an amount of 3% by mass with respect to 100% by mass of the sulfide solid electrolyte and the sulfide solid electrolyte. These are blended into butyl butyrate so as to have a solid content of 50% by mass. The blended mixture was subjected to ultrasonic dispersion treatment for 1 minute using an ultrasonic dispersion apparatus to obtain a solid electrolyte paste.

Then, the nonwoven fabric was placed on a 25-μm-thick release film (Si coated PET film), and the solid electrolyte paste was uniformly applied by blade coating using a commercially available applicator so that the basis weight was 3.0 mg/cm².

Thereafter, the obtained coating film was dried at 100° C. for 60 minutes to obtain a solid electrolyte layer containing a nonwoven fabric on the release film.

In addition, the volume ratio (%) of the nonwoven fabric to the volume of the solid electrolyte layer was calculated from the basis weight and specific gravity of the solid electrolyte and the basis weight and specific gravity of the nonwoven fabric. The volume ratio of the nonwoven fabric to the volume of the solid electrolyte layer was 35%. The results are shown in Table 1.

### Preparation of Cathode

As the cathode active material, particles having an average particle diameter (D50) of 10 μm and a specific surface area of 1 m²/g of LiNi_{1/3}Mn_{1/3}Co_{1/3}O₂ were used.

Then, a LiNbO₃ was coated on the cathode active material using a sol-gel method. As the solid electrolyte, the same sulfide solid electrolyte as that of the solid electrolyte layer was used.

50% by mass of a sulfide solid electrolyte, 10% by mass of a conductive material (CNF, specific surface area 14 m²/g), and 1% by mass of a SBR (styrene-butadiene rubber)-based binder are weighed with respect to 100% by mass of the cathode active material and the cathode active material. These are blended into butyl butyrate so as to have a solid content of 60% by mass. The compounded mixture was subjected to ultrasonic dispersion treatment using an ultrasonic dispersion apparatus for 1 minute to obtain a cathode paste.

Next, the obtained cathode paste was uniformly applied by blade coating using a commercially available applicator on a cathode current collector made of aluminum foil having a thickness of 15 μm so that the basis weight was 25 mg/cm².

Thereafter, the obtained coating film was dried at 100° C. for 60 minutes to obtain a cathode having a cathode layer formed on a cathode current collector made of aluminum foil.

### Preparation of the Anode

As the anode active material, particles of Si having an average particle diameter (D50) of 3 μm and a specific surface area of 4 m²/g were used, and as the sulfide solid electrolyte, the same sulfide solid electrolyte as that of the solid electrolyte layer was used.

To 100% by mass of the anode active material and the anode active material, 100% by mass of a sulfide solid electrolyte, 10% by mass of a conductive material (CNF, specific surface area 14 m²/g), and 2% by mass of a SBR (styrene-butadiene rubber)-based binder are weighed. These are blended into butyl butyrate so as to have a solid content of 40% by mass.

The compounded mixture was subjected to ultrasonic dispersion treatment using an ultrasonic dispersion apparatus for 1 minute to obtain an anode paste.

Next, the obtained anode paste was uniformly applied by blade coating using a commercially available applicator on an anode current collector made of surface-roughened copper foil having a thickness of 20 μm so that the basis weight was 5 mg/cm².

Thereafter, the obtained coating film was dried at 100° C. for 60 minutes to obtain an anode having an anode layer formed on an anode current collector made of a surface roughened copper foil.

### Preparation of Solid-State Battery

The anode was cut into a 1.2 cm×1.2 positive square shape, and a solid electrolyte layer with a release film cut out in the same shape on the anode layer was superposed so that the anode layer and the solid electrolyte layer were in contact with each other, and rolled and pressed at a press pressure of 1 ton/cm.

Next, the release films attached to the solid electrolyte layer placed on the anode are peeled off, and the cathode is cut into 1.0 cm×1.0 cm square shapes. The cathode layer and the solid electrolyte layer were superposed on the solid electrolyte layer laminated on the anode so as to be in contact with each other, and then roll-pressed at a press pressure of 4 tons/cm. The stack thus obtained was sealed with an exterior body made of an aluminum laminate film to which a cathode terminal and an anode terminal were attached in advance, and a solid-state battery (all-solid-state lithium-ion secondary battery) for testing of Example 1 was produced.

### Example 2

A solid-state battery was prepared in the same manner as in Example 1 except that a nonwoven fabric made of PET having a thickness of 30 μm and a porosity of 79% was used. The volume ratio of the nonwoven fabric to the volume of the solid electrolyte layer was 42%.

### Example 3

A solid-state battery was prepared in the same manner as in Example 1 except that a nonwoven fabric made of PET having a thickness of 30 μm and a porosity of 77% was used. The volume ratio of the nonwoven fabric to the volume of the solid electrolyte layer was 46%.

### Example 4

A solid-state battery was prepared in the same manner as in Example 1 except that a nonwoven fabric made of PET having a thickness of 30 μm and a porosity of 75% was used. The volume ratio of the nonwoven fabric to the volume of the solid electrolyte layer was 50%.

### Example 5

A solid-state battery was prepared in the same manner as in Example 1 except that a nonwoven fabric made of PET having a thickness of 30 μm and a porosity of 73% was used. The volume ratio of the nonwoven fabric to the volume of the solid electrolyte layer was 54%.

### Comparative Example 1

A solid-state battery was prepared in the same manner as in Example 1 except that a nonwoven fabric was not used.

### Comparative Example 2

A solid-state battery was prepared in the same manner as in Example 1 except that a nonwoven fabric made of PET having a thickness of 30 μm and a porosity of 84% was used. The volume ratio of the nonwoven fabric to the volume of the solid electrolyte layer was 32%.

### Comparative Example 3

A solid-state battery was prepared in the same manner as in Example 1 except that a nonwoven fabric made of PET having a thickness of 30 μm and a porosity of 69% was used. The volume ratio of the nonwoven fabric to the volume of the solid electrolyte layer was 62%.

### Battery Resistance Measurement

The solid-state batteries prepared in Examples 1 to 5 and Comparative Examples 1 to 3 were charged with CCCV under the conditions of a current 2 mA, an upper limit voltage 4.5 V, and a lower limit voltage 2.5 V, and then CCCV discharged. Then, CCCV charge was performed at the current value 2 mA and the upper limit voltage 3.6 V, and CC discharging was performed at the current value 10 mA and the lower limit voltage 0.0 V for 10 seconds after the pause for 10 minutes, and the battery (cell) resistance R (=ΔV/I) was calculated according to Ohm's law. The results are shown in Table 1.

### Tensile Strength Measurement

For the solid electrolyte layers prepared in Examples 1 to 5 and Comparative Examples 2 and 3, the tensile strength was measured by the following methods with reference to JISL1096.

The laminate obtained by further stacking the release film on the solid electrolyte paste coated surface of the solid electrolyte layer on the release film prepared in [Preparation of the solid electrolyte layer] is roll-pressed at a press pressure of 1 ton/cm. The release films on both surfaces of the solid electrolyte layer were peeled off to form a free-standing solid electrolyte layer. The free-standing solid electrolyte layers were cut into strips in 1 cm of width×length 5 cm, and the tensile strength was measured by a predetermined tensile test. The results are shown in Table 1.

TABLE 1

| | | | Nonwoven | | |
|---|---|---|---|---|---|
| | | | fabric | Tensile | |
| | | | volume ratio | strength of | Battery |
| | Nonwoven | Nonwoven | in solid | the solid | resistance |
| | Fabric | fabric | electrolyte | electrolyte | Ratio to |
| | thickness | porosity | layer | layer | Comparative |
| | μm | % | % | N/cm | Example 1 |
| Comparative | — | — | — | — | 1.00 |
| Example 1 | | | | | |
| Comparative | 30 | 84% | 32 | 0.8 | 1.91 |
| Example 2 | | | | | |
| Example 1 | 30 | 83% | 35 | 1.0 | 1.89 |
| Example 2 | 30 | 79% | 42 | 1.4 | 1.96 |
| Example 3 | 30 | 77% | 46 | 1.7 | 1.98 |
| Example 4 | 30 | 75% | 50 | 2.1 | 2.00 |
| Example 5 | 30 | 73% | 54 | 2.5 | 2.13 |
| Comparative | 30 | 69% | 62 | 3.6 | 2.78 |
| Example 3 | | | | | |

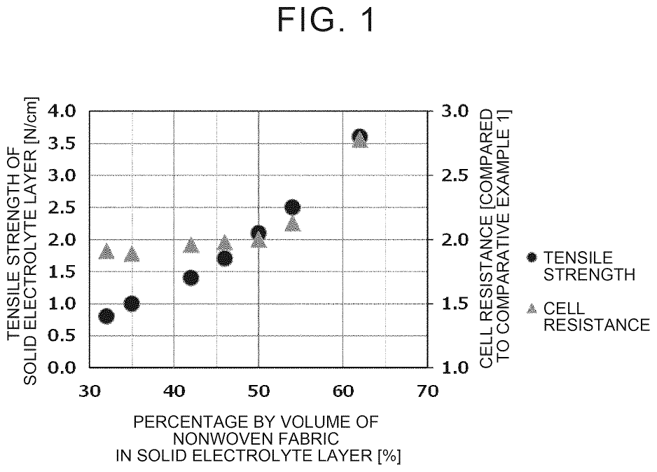

FIG. 1 is a graph showing the relationship between the volume ratio (%) of the nonwoven fabric in each of the solid electrolyte layers, the tensile strength of each of the solid electrolyte layers, and the resistance of each of the solid-state batteries prepared in Examples 1 to 5 and Comparative Examples 2 to 3.

As shown in FIG. 1 and Table 1, the volume ratio of the nonwoven fabric to the volume of the solid electrolyte layer is desired to be as large as possible from the viewpoint of increasing the tensile strength of the solid electrolyte layer. However, as shown in Comparative Example 3, when the volume ratio of the nonwoven fabric to the volume of the solid electrolyte layer is greater than 54%, the battery resistance is greatly increased. As shown in Comparative Example 2, if the volume ratio of the nonwoven fabric to the volume of the solid electrolyte layer is too small, the battery resistance is reduced, but the allowable value 1.0 or more of the tensile strength is not satisfied. When the volume ratio of the nonwoven fabric to the volume of the solid electrolyte layer is 35% or more and 54% or less, the allowable value 1.0 or more of the tensile strength is satisfied, and the battery resistance can be reduced to a desired battery resistance.

What is claimed is:

1. A solid electrolyte layer for a solid-state battery, the solid electrolyte layer comprising a nonwoven fabric; and a solid electrolyte, wherein:
the solid electrolyte is disposed in the nonwoven fabric; and
a ratio of a volume of the nonwoven fabric to a volume of the solid electrolyte layer is 35% or more and 54% or less.

2. The solid electrolyte layer according to claim 1, wherein the nonwoven fabric has a porosity of 73% or more and 83% or less.

3. The solid electrolyte layer according to claim 1, wherein the nonwoven fabric is composed of polyethylene terephthalate.

4. The solid electrolyte layer according to claim 1, wherein the solid electrolyte includes a sulfide solid electrolyte.

5. A method for manufacturing a solid-state battery, the method comprising:
obtaining a stack by disposing the solid electrolyte layer according to claim 1 between an anode layer and a cathode layer; and
pressing the stack.
